(19) United States
(12) Patent Application Publication
(10) Pub. No.: US 2009/0169177 A1
(43) Pub. Date: Jul. 2, 2009

(54) STREAM MULTIPLEXING APPARATUS, STREAM MULTIPLEXING METHOD, AND RECORDING MEDIUM

(75) Inventor: Shunji Ui, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/342,014

(22) Filed: Dec. 22, 2008

(30) Foreign Application Priority Data
Dec. 27, 2007 (JP) 2007-335978

(51) Int. Cl. H04N 5/91

(52) U.S. Cl. 386/98; 386/E05.021

(57) ABSTRACT

The present invention provides a stream multiplexing apparatus, a stream multiplexing method, and a recording medium capable of, easily and seamlessly and without holding redundant data, reproducing each of a plurality of stories which share at least one system stream. A stream multiplexing apparatus according to the present invention includes a multiplexing control unit. In the multiplexing of a system stream included in a first group and a system stream, subject to be selectively and seamlessly reproduced subsequently to the system stream included in the first group, included in a second group, the multiplexing control unit controls the multiplexing of respective system streams such that the difference between a video and an audio reproduction end times of the system stream included in the first group is equalized with the difference between a video and an audio reproduction start times of the system stream included in the second group.

### CROSS-REFERENCE TO RELATED APPLICATIONS

This application claims the benefit of priority of Japanese Patent Application No. 2007-335978, filed Dec. 27, 2007, the entire contents of which are incorporated herein by reference.

### BACKGROUND

1. Field

The present invention relates to a stream multiplexing apparatus and a stream multiplexing method for multiplexing an encoded video stream and an encoded audio stream, and a recording medium for recording the multiplexed streams.

2. Description of the Related Art

Some of recording media such as DVDs have previously been recorded with a plurality of branching (selectively reproducible) scenes such that a story can be divided into different scenes during the story in accordance with a selection by a user.

For example, with respect to a story reproduced in the order of the first scene, the second scene, and the third scene, to create a story reproduced with the first scene followed by the fourth scene and then by the third scene, the second and fourth scenes are previously recorded on a recording medium as selectively reproducible scenes, in addition to the first and third scenes.

In this case, the data at the beginning of each of the second and fourth scenes is configured to be mergeable with the data at the end of the first scene. Further, the data at the end of each of the second and fourth scenes is configured to be mergeable with the data at the beginning of the third scene. Generally, however, if two scenes are connected together for the merger, an audio gap is generated between the end of the merging scene and the beginning of the merged scene.

Conventionally, a variety of stream multiplexing techniques for multiplexing system streams of the respective scenes have been proposed to enable, when there is a scene merged by different scenes, seamless reproduction in the merger between the merged scene (the third scene in the above example) and any one of the different scenes (the second and fourth scenes in the above example) (see Japanese Unexamined Patent Application Publication No. 2003-153206, for example).

Generally, an audio gap, generated between the end of a system stream of a selectively reproducible scene (the second or fourth scene in the above example) and the beginning of a system stream of a merged scene (the third scene in the above example), is included in the system stream of the merged scene. Therefore, the merged scene needs to include different audio gaps in preparation for the merger with each of the selectively reproducible scenes, depending on the selected scene. This means that the same number of scenes as the number of the selectively reproducible scenes needs to be previously prepared as the merged scenes.

Meanwhile, the technique proposed in the above publication is a technique of performing stream multiplexing such that a part of the beginning of the system stream of the merged scene (merged system stream) is previously included in the each end of the system streams of the selectively reproducible scenes (merging system streams). Therefore, the audio gap generated between the end of the merging system stream and the beginning of the merged system stream is previously included in the merging system stream. According to the technique proposed in the above publication, therefore, the seamless reproduction can be performed with no need to prepare a plurality of merged system streams.

In the technique proposed in the above publication, however, data exactly the same as the data of a part of the beginning of the merged system stream needs to be previously included in all of the selectively reproducible system streams. Therefore, the system streams multiplexed by the conventional technique involve redundant data and are large in data size.

Further, if a selectively reproducible system stream is merged by another system stream, two gaps including a gap generated by the merger are included in the selectively reproducible system stream. In this case, two audio gaps are generated in each selectively reproducible system stream, and the sound is interrupted at each of the audio gaps in the reproduction process.

Further more, the conventional technique cannot cope with a story configuration in which a plurality of selectively reproduced scenes is connected to another plurality of selectively reproduced scenes.

### SUMMARY OF THE INVENTION

The present invention has been made in view of the circumstances described above, and it is an object of the present invention to provide a stream multiplexing apparatus, a stream multiplexing method, and a recording medium capable of, easily and seamlessly and without holding redundant data, reproducing each of a plurality of stories which share at least one system stream.

To solve the above-described issues, a stream multiplexing apparatus according to an aspect of the present invention multiplexes an encoded video stream and an encoded audio stream in one system stream, and includes a video packetizing unit, an audio packetizing unit, a packet multiplexing unit, and a multiplexing control unit. The video packetizing unit fragments the video stream into video packets each having a predetermined size, and adds to each of the video packets video decoding synchronization information including at least information of an input time to a video decoder and a video reproduction time. The audio packetizing unit fragments the audio stream into audio packets each having a predetermined size, and adds to each of the audio packets audio decoding synchronization information including at least information of an input time to an audio decoder and an audio reproduction time. The packet multiplexing unit multiplexes the video packets and the audio packets to generate the system stream. The multiplexing control unit controls the video packetizing unit, the audio packetizing unit, and the packet multiplexing unit to control a multiplexing order and a multiplexing position of each of the video packets and the audio packets. In the multiplexing of a system stream included in a first system stream group including one or more system streams and subject to be selectively and seamlessly reproduced and a system stream, subject to be selectively and seamlessly reproduced subsequently to the system stream included in the first system stream group, included in a second system stream group including one or more system streams, the multiplexing control unit controls the audio decoding synchronization information and a packetization start position and a packetization end position of the audio stream of each of the system streams included in the first and second system stream groups such that the difference between a video reproduction end time and an audio reproduction end time of each of the system streams included in the first system stream group is equalized with the difference between a video reproduction start time and an audio reproduction start time of each of the system streams included in the second system stream group.

Further, to solve the above-described issues, a stream multiplexing method according to an aspect of the present invention multiplexes an encoded video stream and an encoded audio stream in one system stream, and includes: a step of fragmenting the video stream into video packets each having a predetermined size, and adding to each of the video packets video decoding synchronization information including at least information of an input time to a video decoder and a video reproduction time; a step of fragmenting the audio stream into audio packets each having a predetermined size, and adding to each of the audio packets audio decoding synchronization information including at least information of an input time to an audio decoder and an audio reproduction time; a step of multiplexing the video packets and the audio packets to generate the system stream; and a step of controlling a multiplexing order and a multiplexing position of each of the video packets and the audio packets. In the multiplexing of a system stream included in a first system stream group including one or more system streams and subject to be selectively and seamlessly reproduced and a system stream, subject to be selectively and seamlessly reproduced subsequently to the system stream included in the first system stream group, included in a second system stream group including one or more system streams, the step of controlling the multiplexing order and the multiplexing position controls the audio decoding synchronization information and a packetization start position and a packetization end position of the audio stream of each of the system streams included in the first and second system stream groups such that the difference between a video reproduction end time and an audio reproduction end time of each of the system streams included in the first system stream group is equalized with the difference between a video reproduction start time and an audio reproduction start time of each of the system streams included in the second system stream group.

Meanwhile, to solve the above-described issues, a recording medium according to an aspect of the present invention records a system stream in which an encoded video stream and an encoded audio stream are multiplexed. The recording medium is recorded with a first system stream group including one or more system streams and selectively and subject to be seamlessly reproduced and a second system stream group including one or more system streams and subject to be selectively and seamlessly reproduced subsequently to the first system stream group. In the recording medium, the difference between a video reproduction end time and an audio reproduction end time of each of the system streams included in the first system stream group is equal to the difference between a video reproduction start time and an audio reproduction start time of each of the system streams included in the second system stream group.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram illustrating a configuration example of a stream multiplexing apparatus and a recording medium according to an embodiment of the present invention;

FIG. 2 is a diagram illustrating a data structure of MPEG2/PS in a hierarchy divided into a pack layer and a packet layer;

FIG. 3 is a diagram illustrating a configuration of an ideal decoder (STD) used in the MPEG2/PS to determine the technical specifications of the MPEG2/PS;

FIG. 4 is an explanatory diagram illustrating a process of encoding each of video signals and audio signals of continuous scenes and performing packet multiplexing to generate system streams;

FIGS. 5A and 5B are an explanatory diagram schematically illustrating phases of the reproduced video and audio signals of a plurality of system streams, each of the system streams having a common system stream before and after the system stream;

FIGS. 6A and 6B are a diagram illustrating a configuration example of respective system streams obtained by conversion of two stories illustrated in FIGS. 5A and 5B into the system streams for the respective scenes, wherein the system streams are shown in sections in which video streams and audio streams are multiplexed;

FIGS. 7A and 7B are a diagram illustrating a state in which two audio gaps are involved in each of the system streams included in a selectively reproducible scene group of two stories illustrated in FIGS. 6A and 6B (a method of systematizing a title dividable into different scenes during the story);

FIG. 8 is a diagram for explaining a story configuration which includes three selectively reproducible scene groups, and in which scenes each selected from one of the scene groups are continuously reproduced;

FIG. 9A is a diagram illustrating a configuration of system streams according to a first embodiment;

FIGS. 9B and 9C are diagrams illustrating video and audio reproduction timings in the reproduction of the system streams, wherein FIG. 9B illustrates a time chart in continuous reproduction of system streams A, B1, and C, and FIG. 9C illustrates a time chart in continuous reproduction of system streams A, B2, and C;

FIG. 10A is a diagram illustrating a configuration of system streams according to a second embodiment;

FIGS. 10B to 10E are diagrams illustrating video and audio reproduction timings in the reproduction of the system streams, wherein FIG. 10B illustrates a time chart in continuous reproduction of system streams A1, B1, and C1, FIG. 10C illustrates a time chart in continuous reproduction of system streams A2, B1, and C2, FIG. 10D illustrates a time chart in continuous reproduction of system streams A1, B2, and C1, and FIG. 10E illustrates a time chart in continuous reproduction of system streams A2, B2, and C2;

FIG. 11A is a diagram illustrating a configuration of system streams according to a third embodiment;

FIG. 11B to 11E are diagrams illustrating video and audio reproduction timings in the reproduction of the system streams, wherein FIG. 11B illustrates a time chart in continuous reproduction of system streams A1, B1, and C1, FIG. 11C illustrates a time chart in continuous reproduction of system streams A2, B1, and C2, FIG. 11D illustrates a time chart in continuous reproduction of system streams A1, B2, and C1, and FIG. 11E illustrates a time chart in continuous reproduction of system streams A2, B2, and C2; and

FIG. 12 is a flowchart for explaining an example of operations of the stream multiplexing apparatus according to the embodiment of the present invention, particularly operations relating to a video-audio synchronization control performed by a multiplexing control unit.

### DETAILED DESCRIPTION

Hereinbelow, a description will be given of a stream multiplexing apparatus, a stream multiplexing method, and a recording medium, according to an embodiment of the present invention with reference to the drawings.

### (1) Configuration of Stream Multiplexing Apparatus

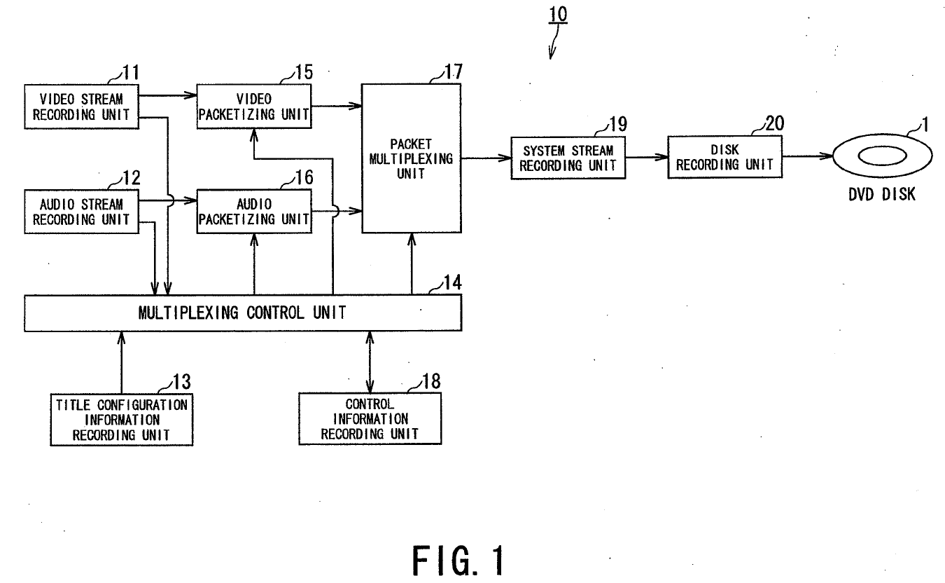

FIG. 1 is a diagram illustrating a configuration example of a stream multiplexing apparatus and a recording medium according to an embodiment of the present invention.

A stream multiplexing apparatus 10 performs a process of multiplexing an encoded video stream and an encoded audio stream to generate a system stream and record the system stream on a recording medium (a DVD disk 1).

A video stream recording unit 11 is recorded with the encoded video stream and reproduction time information of the video stream.

An audio stream recording unit 12 is recorded with the encoded audio stream and reproduction time information of the audio stream.

A title configuration information recording unit 13 is recorded with individual scene configuration information and scene connection information. The individual scene configuration information is the information of video and audio constituting an individual scene, i.e., the information as to a portion at which time and of which one of the video streams recorded in the video stream recording unit 11 and a portion at which time and of which one of the audio streams recorded in the audio stream recording unit 12 are selected for use. Further, the scene connection information represents the connection relationship, such as a connection relationship in which scenes B1 and B2 are selectively reproduced and are seamlessly reproduced subsequently to a scene C.

On the basis of the individual scene configuration information and the scene connection information, a multiplexing control unit 14 determines video-audio synchronization (lip-sync) and a packetization start position (a start frame) and a packetization end position (an end frame) of each of the video stream and the audio stream corresponding to each scene, and controls a video packetizing unit 15, an audio packetizing unit 16, and a packet multiplexing unit 17.

A control information recording unit 18 is recorded with a variety of parameters calculated by the multiplexing control unit 14.

On the basis of packetization control information including the start and end frames received from the multiplexing control unit 14, the video packetizing unit 15 sequentially reads from the video stream recording unit 11 data sets of a video stream, each data set having a predetermined packet length size, by starting from the start frame of the stream. And the video packetizing unit 15 adds to each of the packet data sets a packet header including synchronization information, such as DTS (Decoding Time Stamp) and PTS (Presentation Time Stamp), to thereby generate video packets.

On the basis of the packetization control information received from the multiplexing control unit 14, the audio packetizing unit 16 sequentially reads from the audio stream recording unit 12 data sets of an audio stream, each data set having a predetermined packet length size, by starting from the start frame of the stream. And the audio packetizing unit 16 adds to each of the packet data sets a packet header including synchronization information, such as DTS and PTS, to thereby generate audio packets.

On the basis of multiplexing position control information including the video-audio synchronization (lip-sync) information received from the multiplexing control unit 14, the packet multiplexing unit 17 selects the video packets and the audio packets generated by the video packetizing unit 15 and the audio packetizing unit 16, respectively, adds to each of the video packets and the audio packets a pack header including an SCR (System Clock Reference) representing the multiplexing time in a system stream, and records the video packets and the audio packets in a system stream recording unit 19.

A disk recording unit 20 converts the generated system stream into a format depending on the storage medium, such as a format involving the addition of an error-correcting code, and records the system stream on the DVD disk 1 serving as a recording medium.

### (2) MPEG2/PS

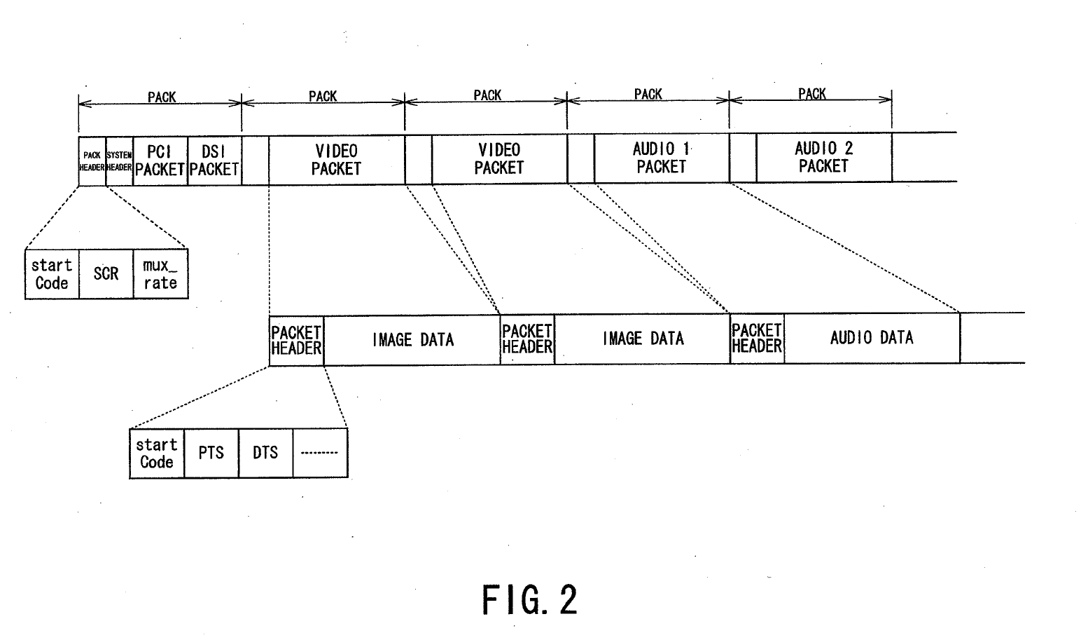

FIG. 2 is a diagram illustrating a data structure of MPEG2/PS in a hierarchy divided into a pack layer and a packet layer. As illustrated in FIG. 2, data is configured in units of packs. Each pack is constituted by a pack header, a system header, and one or more packets. A pack start code, an SCR, the bit rate of the corresponding system stream, and so forth are described in the pack header. Parameters of the entire stream are described in the system header. The system header is added at least to the first pack.

Each packet is constituted by a packet header and a single unit stream of packet data. A packet start code, a packet length, a PTS, a DTS, and so forth are described in the packet header.

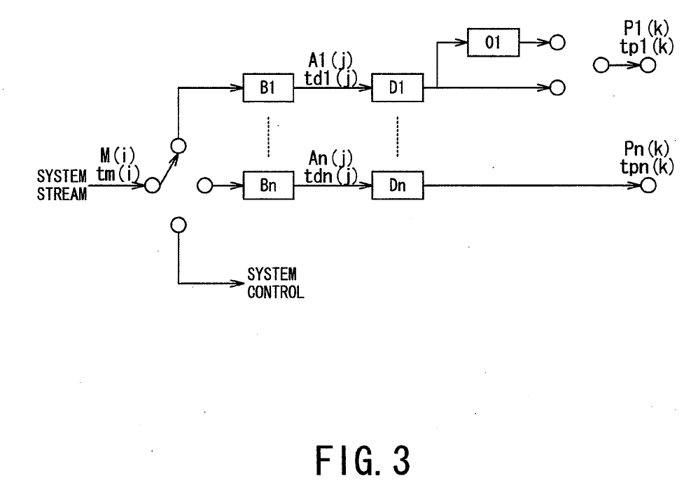

FIG. 3 is a diagram illustrating a configuration of an ideal decoder called STD (System Target Decoder) used in the MPEG2/PS to determine the technical specifications of the MPEG2/PS. In the MPEG2/PS standard, the STD is defined to specify the synchronization and the buffer management. Operation of the STD will be briefly described.

The i-th byte M(i) of a system stream is input to the STD at a time tm(i). The time tm(i) can be calculated from the bit rate and the SCR described in the pack header of the pack including the byte, i.e., from the bit rate and a time tm(i′) at which the last byte M(i′) of the SCR field is input to the STD. The input time tm(i′) is described in the SCR of each pack.

Further, the packet data of a unit stream n of the system stream input to the STD is instantaneously input to an input buffer Bn. The size of the input buffer Bn is described in a syntax. At a time tdn(j), the j-th access unit An(j) of the unit stream n, which has been stored in the input buffer Bn for the longest time, is instantaneously deleted from the buffer, and is instantaneously decoded by a decoder Dn and output as a presentation unit Pn(k) which is reproduced in the k-th place.

Herein, in the case of data according to MPEG1-Video standardized by ISO/IEC 11172-2 or MPEG2-Video standardized by ISO/IEC 13818-2, for example, the access unit refers to an I-, P-, or B-picture. In the case of audio data, the access unit refers to an audio frame constituting a minimum decoding unit.

The presentation unit Pn(k) is instantaneously reproduced at a time tpn(k). In this case, if the unit stream n is the MPEG-Video data, a reorder buffer On delays the I- or P-picture before the output thereof from the STD, to thereby perform reordering from the access unit order to the presentation unit order.

As described above, the input time tm(i′), at which the last byte of the SCR field is input to the STD, is described in the SCR of each pack. Further, the decoding time tdn(j) and the reproduction time tpn(k) of the first access unit of each packet are described in the DTS and the PTS of the individual packet, respectively. If the decoding time tdn(j) is equal to the reproduction time tpn(k), the DTS can be omitted.

As described above, the decoder can establish the synchronization between the respective streams in the decoder by performing the decoding and reproduction on the basis of the time information described in the system stream.

### (3) Stream Multiplexing

### (3-1) Overview

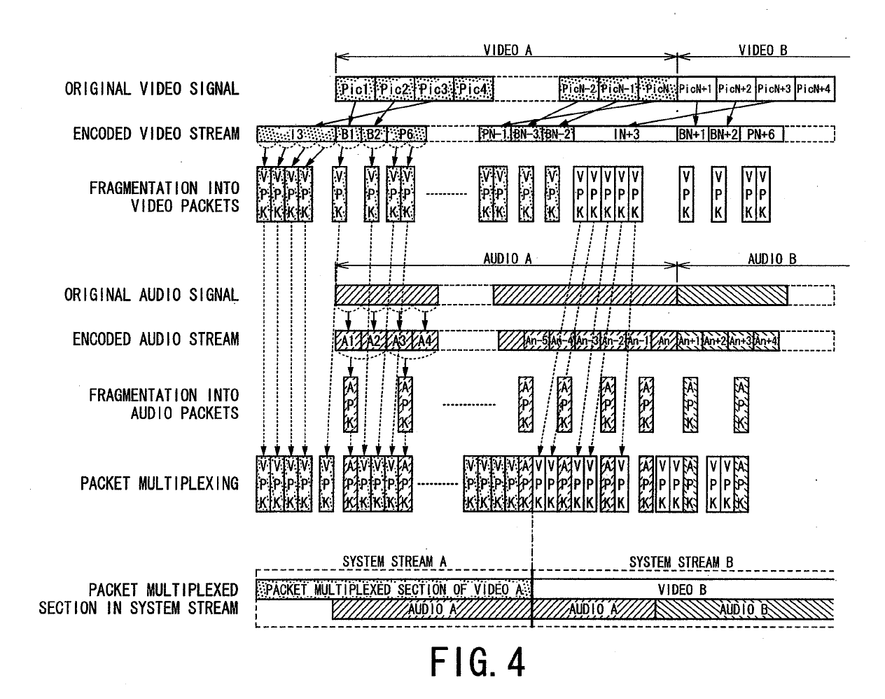

FIG. 4 is a diagram illustrating a process of encoding video signals VIDEO A and VIDEO B of continuous scenes A and B and audio signals AUDIO A and AUDIO B of the scenes A and B, and performing packet multiplexing on the encoded signals to generate system streams A and B. Herein, the MPEG2 is used as the method for encoding the video signals, and an encoding method of encoding signals in units of a fixed sample number of frames, such as Dolby Digital (a registered trademark) or dts (a registered trademark), is used as the method for encoding the audio signals, for example.

Each of the video signals is encoded for each picture. In the MPEG2, there are three types of pictures, i.e., the I-, P-, and B-pictures. The I-picture is obtained by an intra coding method of generating a coded signal from a picture signal of the picture. Each of the P- and B-pictures is obtained by a predictive coding method of coding the difference between a picture signal of the picture and a reference picture signal. Between the P- and B-pictures using the predictive coding method, the P-picture uses, as the reference picture signal, the I- or P-picture reproduced at an earlier time than the picture (the forward reference picture). Meanwhile, the B picture also uses, as the reference picture signal, the I- or P-picture reproduced later than the picture (the backward reference picture), in addition to the forward reference picture.

To decode the B-picture, decoding of the backward reference picture needs to be completed to obtain the reference picture signal. In an encoded video stream, therefore, reordering is performed such that the subsequent I- or P-picture referred to by the B-picture precedes the B-picture.

In FIG. 4, each of the encoded video streams includes encoded data obtained by the encoding of the corresponding original video signal. Herein, encoded data I3 of the third picture data Pic3 is placed before encoded data B1 of the first picture data Pic1, for example. This is because of the reordering performed for the backward reference.

Meanwhile, the audio signals are encoded in units of a fixed sample number of frames. In FIG. 4, each of the encoded audio streams includes encoded data obtained by the encoding of the corresponding original audio signal. Unlike the video signals, the audio signals are not subjected to the reordering.

Then, the video packetizing unit 15 and the audio packetizing unit 16 fragment the encoded video streams and the encoded audio streams, respectively, which have been obtained by the encoding, into packets each having a data size of a predetermined length (see FRAGMENTATION INTO VIDEO PACKETS and FRAGMENTATION INTO AUDIO PACKETS in FIG. 4). For example, in DVD-Video, the data length of each packet is approximately two kilobytes.

By using, as units, the data thus fragmented into the packets, the packet multiplexing unit 17 multiplexes the video stream and the audio stream in one system stream (see PACKET MULTIPLEXING in FIG. 4). The multiplexing order and the multiplexing time (the multiplexing position control information) of each of the packets are determined by the multiplexing control unit 14 such that the time for transmitting each of the packets to the decoder precedes the DTS representing the decoding start time, that the transmission times of the respective packets are in the right order, and that there is no overlapping of the transmission times.

Further, in the packet multiplexing, each of the packet data sets is added with the pack header and the packet header. The SCR is described in the pack header as the multiplexing time of the packet, i.e., the time for transmitting the data of the packet to the decoder. The DTS and the PTS are described in the packet header as the decoding start time and the reproduction time of the access unit of the packet, respectively. Accordingly, the reproduction synchronization between the video stream and the audio stream multiplexed in the system stream can be controlled.

FIG. 4 illustrates the system streams A and B converted for the scenes A and B, respectively. In the DVD-Video or HD DVD-Video standard, a system stream is fragmented in units of video frames.

In the video encoding, the reordering is normally performed. The I- or P-picture needs to have been decoded as the reference picture a few frames before the reproduction time thereof to precede the B- or P-picture to be reproduced. Therefore, the I- or P-picture is multiplexed a few frames before the reproduction time thereof.

Meanwhile, the decoding of the audio data can be completed just before the reproduction time of the audio frame thereof. Further, the size of the input buffer for the audio data is smaller than the size of the input buffer for the video data. Therefore, the audio data is multiplexed at a time earlier than and close to the reproduction time of the audio frame thereof.

As a result, a portion at the end of the audio stream of the reproduced scene A is moved into the initial portion of the system stream of the scene B to be multiplexed therein.

The DVD-Video standard and the like (hereinafter referred to as the DVD standard) specify an E-STD (Enhanced STD Model), which is an extended version of the STD model. According to the E-STD, even if the SCR at the end of a preceding system stream and the SCR at the beginning of a subsequent system stream are discontinuous, it is possible to perform reproduction similar to the reproduction of one system stream having continuous SCRs.

### (3-2) Stream Multiplexing Involving Divided Story

In the DVD, a title enabling division of a story into different scenes during the story (it means that the title provides different stories) in accordance with a selection by a user can be created.

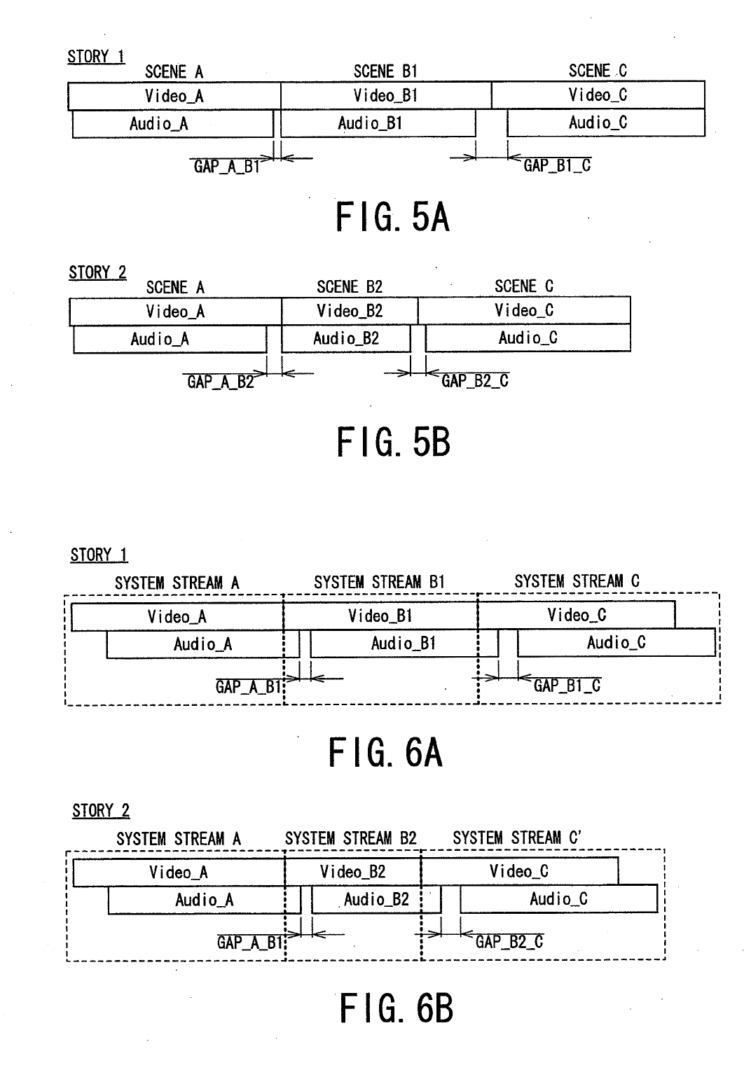

FIGS. 5A and 5B are an explanatory diagram schematically illustrating phases of the reproduced video and audio signals of a plurality of system streams, each of the system streams having a common system stream before and after to be connected. FIGS. 5A and 5B illustrate an example which includes the scenes B1 and B2 in a selectively reproducible scene group, and in which either one of stories 1 and 2 can be arbitrarily reproduced. The story 1 is reproduced in a sequence of the scenes A, B1, and C, while the story 2 is reproduced with the scene B2 selected in place of the scene B1.

In the creation of a plurality of stories sharing scenes (the scenes A and C in FIGS. 5A and 5B), each of the scenes is configured as one system stream and the system streams of the common scenes are shared by the plurality of stories to save the storage capacity.

The video frame and the audio frame are different from each other in the reproduction length. Therefore, in an attempt to continuously and uninterruptedly reproduce the video signals while maintaining the phase synchronization of the video and audio signals in the respective scenes, a gap smaller than one audio frame is generated at each of boundaries between the scenes, unless the length of each of the scenes is equal to a common multiple of the reproduction length of the video frame and the reproduction length of the audio frame.

In the DVD standard, an audio gap smaller than one audio frame is prepared to absorb the difference between the video reproduction time and the audio reproduction time.

For example, in FIGS. 5A and 5B, GAP_A_B1 represents an audio gap generated in the continuous reproduction of the video signals of the scenes A and B1, and GAP_A_B2 represents an audio gap generated in the continuous reproduction of the video signals of the scenes A and B2. In the DVD, the start time and the length of each of the audio gaps are required to be recorded, as audio gap information, in a DSI (Data Search Information) packet multiplexed in the corresponding system stream (see FIG. 2). A DVD player reads the audio gap information, and temporarily stops the audio decoding for a time period starting from the audio gap start time and lasting for the gap length, to thereby maintain the synchronization between the video reproduction and the audio reproduction.

FIGS. 6A and 6B are a diagram illustrating a configuration example of respective system streams obtained by conversion of the two stories illustrated in FIGS. 5A and 5B into the system streams for the respective scenes, wherein the system streams are shown in sections in which the video streams and the audio streams are multiplexed. FIGS. 6A and 6B also illustrate the audio gaps generated in the reproduction process, on the assumption that the audio packets are reproduced substantially with no delay.

As illustrated in FIGS. 6A and 6B, the scene A is configured to be exactly the same between the stories 1 and 2, and thus can be shared. Meanwhile, a system stream C for the scene C of the story 1 and a system stream C′ of the story 2 are different from each other in the phase of the audio data moved into the initial portion of the system streams and in the audio gap length. Thus, the scene C in this state cannot be shared.

The DVD standard, therefore, allows inclusion of up to two audio gaps in one system stream, i.e., allows description of the audio gap information of two audio gaps in a navigation packet.

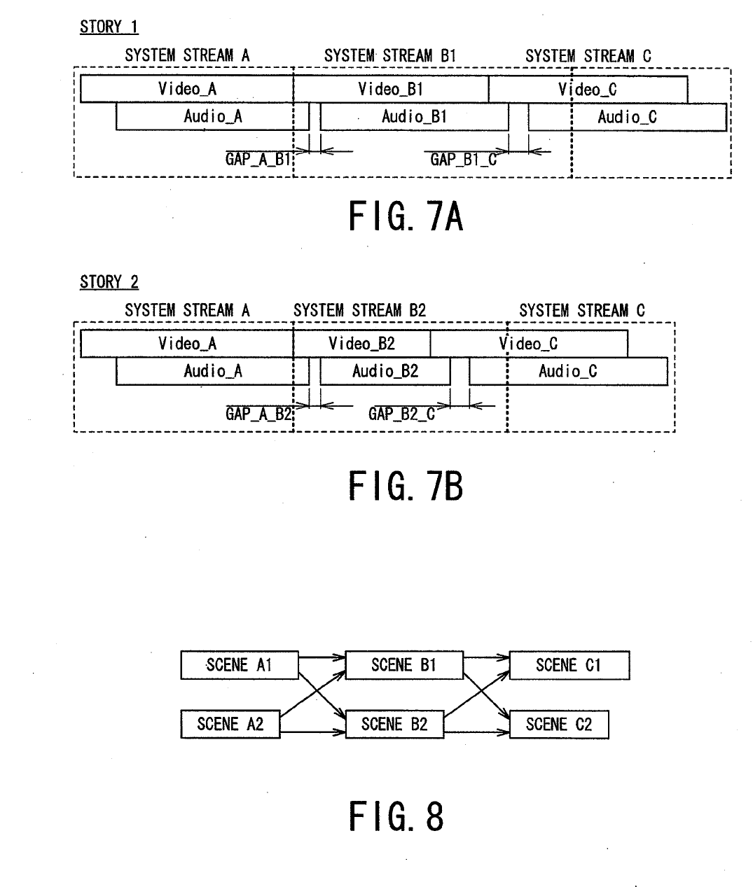

FIGS. 7A and 7B are a diagram illustrating a state in which two audio gaps are involved in each of the system streams included in the selectively reproducible scene group of the two stories illustrated in FIGS. 6A and 6B (a method of systematizing a title dividable into different scenes during the story).

As illustrated in FIGS. 7A and 7B, a portion at the beginning of data Video_C is included in the end of each of the system streams B1 and B2 by the same length, and a portion at the beginning of data Audio_C is included in the end of each of the system streams B1 and B2 by the same length. Thereby, data Audio_B1 and Audio_B2 are prevented from moving into the system stream C, and audio gaps GAP_B1_C and GAP_B2_C are included in the system streams B1 and B2, respectively, as the second audio gap of the system stream B1 and the second audio gap of the system stream B2, respectively. Accordingly, the system stream C of the story 1 and the system stream C of the story 2 have the same configuration, and thus can be shared.

In the inclusion of two audio gaps in each of the system streams constituting the selectively reproducible scene group, however, there arises an issue of an increase in size of data occupying the disk due to redundant data. For example, in the example illustrated in FIGS. 7A and 7B, data exactly the same as the data Video_C and Audio_C multiplexed in the system stream B1 is packetized and multiplexed in the other system stream constituting the selectively reproducible scene group, i.e., the system stream B2 in FIG. 7B.

Further, there is another issue of the generation of two audio gaps in each of the system streams constituting the selectively reproducible scene group, and the resultant interruption of the sound at each of the audio gaps in the reproduction process.

Further more, the method of including two audio gaps in each of the system streams constituting the selectively reproducible scene group cannot provide a title configuration enabling seamless connection of a plurality of selectively reproduced scenes to another plurality of selectively reproduced scenes.

FIG. 8 is a diagram for explaining a story configuration which includes three selectively reproducible scene groups, and in which scenes each selected from one of the scene groups are continuously reproduced.

For example, in an attempt to create a title configuration enabling the selection and reproduction of one of the scenes A1 and A2, one of the scenes B1 and B2, and one of the scenes C1 and C2, as illustrated in FIG. 8, both of the initial portion of data Video_C1 and the initial portion of data Video_C2 cannot be moved into each of the end portion of data Video B1 and the end portion of data Video_B2. Therefore, there is another issue of preventing the sharing of a system stream according to the method illustrated in FIGS. 7A and 7B.

### (4) Operations (First Embodiment)

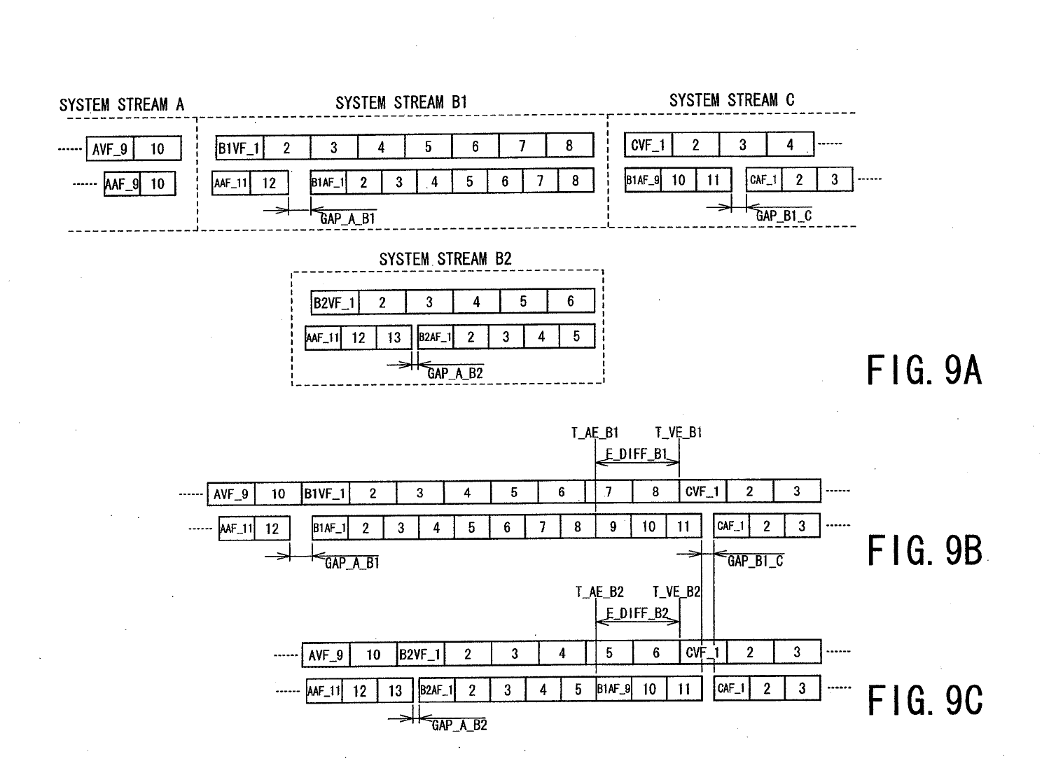

FIG. 9A is a diagram illustrating a configuration of system streams according to a first embodiment. FIGS. 9B and 9C are diagrams illustrating video and audio reproduction timings in the reproduction of the system streams. FIG. 9B illustrates a time chart in continuous reproduction of system streams A, B1, and C. FIG. 9C illustrates a time chart in continuous reproduction of system streams A, B2, and C.

FIGS. 9A to 9C illustrate an example which includes, as a selectively and seamlessly reproducible system stream group, a first system stream group constituted by the system streams B1 and B2. That is, FIGS. 9A to 9C are diagrams illustrating a title configuration including the stories 1 and 2 illustrated in FIGS. 5A and 5B, wherein the story 1 is reproduced in the sequence of the scenes A, B1, and C and the story 2 is reproduced with the scene B2 replacing the scene B1 of the story 1. FIGS. 9A to 9C illustrate the title configuration in the configuration of the system streams obtained through conversion into the system streams by a stream multiplexing method according to the present embodiment, and in the video and audio reproduction timings (the time charts) in the reproduction of the system streams.

In the system stream A, video frames AVF_1 to AVF_10 obtained by the encoding of the video signal of the scene A and audio frames AAF_1 to AAF_10 obtained by the encoding of the audio signal of the scene A are packet-multiplexed. Herein, the decoding delay is increased in the encoded video data due to the reordering, as described above. Therefore, audio frames AAF_11 and AAF_12 are moved into the initial portion of each of the subsequently reproducible system streams B1 and B2 to be packet-multiplexed therein.

In the system stream B1, video frames B1VF_1 to B1VF_8 of the scene B1, the audio frames AAF_11 and AAF_12 of the scene A, and audio frames B1AF_1 to B1AF_8 of the scene B1 are packet-multiplexed.

In the system stream B2, video frames B2VF_1 to B2VF_6 of the scene B2, audio frames AAF_11 to AAF_13 of the scene A, and audio frames B2AF_1 to B2AF_5 of the scene B2 are packet-multiplexed.

In the system stream C, video frames CVF_1 to CVF_n of the scene C, audio frames B1F_9 to B1AF_11 of the scene B1, and audio frames CAF_1 to CAF_m of the scene C are packet-multiplexed.

As for the first selectively reproducible system stream group constituted by the system streams B1 and B2, it is now assumed that the reproduction end time of the last one of the video frames multiplexed in a system stream of the group (the system stream B1), the reproduction end time of the last one of the audio frames multiplexed in the system stream, and the difference therebetween (the difference between the video reproduction end time and the audio reproduction end time) are represented as T_VE_B1, T_AE_B1, and E_DIFF_B1, respectively (see FIG. 9B). Further, it is assumed that the reproduction end time of the last one of the video frames multiplexed in the other system stream of the group (the system stream B2), the reproduction end time of the last one of the audio frames multiplexed in the system stream, and the difference therebetween (the difference between the video reproduction end time and the audio reproduction end time) are represented as T_VE_B2, T_AE_B2, and E_DIFF_B2, respectively (see FIG. 9C). In this case, the stream multiplexing apparatus 10 according to the present embodiment performs the multiplexing by setting the decoding timing and the reproduction timing of each of the audio packets, i.e., the values of the DTS and the PTS of each of the packet headers such that the differences E_DIFF_B1 and E_DIFF_B2 have the same value (see the time charts of FIGS. 9B and 9C).

The above is a process of shifting the original phases of the video signal and the audio signal (lip-sync) by up to one audio frame. For example, in an audio encoding method Dolby Digital (a registered trademark) employed in the DVD, the length of one audio frame is 32 milliseconds, which is within the limit of the shift in the lip-sync normally detectable by a human. Particularly, it is known that a human is two times or more insensitive to the lip-sync delaying the audio reproduction with respect to the video reproduction than to the lip-sync shifted in the inverse direction to advance the audio reproduction. In a change in the lip-sync, therefore, adjustment is made not to advance the audio reproduction with respect to the video reproduction.

Further, after the change in the lip-sync, the number of the audio frames of the scene A, the lip-sync of the audio signal of the scene A, or the number of the audio frames of each of the scenes B1 and B2 is adjusted such that each of the gap between the audio signal of the scene A and the audio signal of the scene B1 and the gap between the audio signal of the scene A and the audio signal of the scene B2 becomes smaller than one audio frame. In the example illustrated in FIGS. 9A to 9C, the number of the audio frames of the scene A moved into the system stream B1 from the scene A and the number of the audio frames of the scene A moved into the system stream B2 from the scene A are set to be two and three, respectively, to make the length of each of audio gaps GAP_A_B1 and GAP_A_B2 smaller than one audio frame.

Further, in the system stream C, the audio frames B1AF_9 to B1AF_11 moved from the audio frames of the scene B1 are packet-multiplexed such that the difference between the reproduction start time of the first video frame CVF_1 and the reproduction start time of the first audio frame B1AF_9 has the same value as the value of the differences E_DIFF_B1 and E_DIFF_B2.

Accordingly, the stories 1 and 2 can be configured by the shared use of the system streams A and C. Further, both in continuous reproduction from the system stream B1 to the system stream C in the story 1 and continuous reproduction from the system stream B2 to the system stream C in the story 2, the system streams can be continuously reproduced until the audio gap GAP_B1_C.

The system stream C includes the audio frames B1AF_9 to B1AF_11, which are the end portion of the scene B1 moved into the system stream C to be multiplexed therein. Therefore, the audio frames B1AF_9 to B1AF_11 are reproduced also in the story 2 between the audio signal of the scene B2 and the audio signal of the scene C. Generally, however, the thus moved portion of the audio signal corresponds to a few frames. Further, at a merger point of the stories, a portion at the end of each of the scenes B1 and B2 having the same sound, a silent sound, or a large noise is selected for natural sound connection from the scene B1 to the scene C and from the scene B2 to the scene C. Accordingly, the continuous audio reproduction can be performed also in the story 2.

Unless the audio input buffer of the STD (System Target Decoder) overflows, it is possible to reduce the number of the moved frames to a smaller number or zero by setting the multiplexing position of each of the audio packets at the earliest possible time.

### (5) Operations (Second Embodiment)

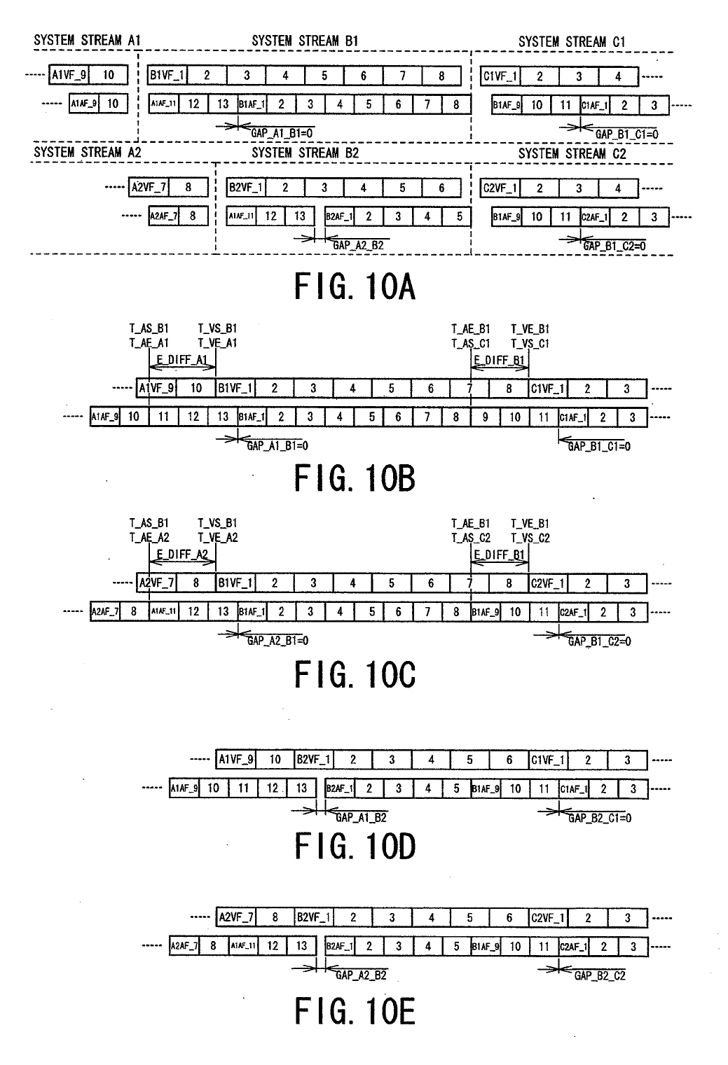

FIG. 10A is a diagram illustrating a configuration of system streams according to a second embodiment. FIGS. 10B to 10E are diagrams illustrating video and audio reproduction timings in the reproduction of the system streams. FIG. 10B illustrates a time chart in continuous reproduction of system streams A1, B1, and C1. FIG. 10C illustrates a time chart in continuous reproduction of system streams A2, B1, and C2. FIG. 10D illustrates a time chart in continuous reproduction of system streams A1, B2, and C1. FIG. 10E illustrates a time chart in continuous reproduction of system streams A2, B2, and C2.

FIGS. 10A to 10E illustrate an example including, as the selectively and seamlessly reproducible system stream groups, the first system stream group constituted by the system streams B1 and B2, a second system stream group constituted by the system streams C1 and C2, and a third system stream group constituted by the system streams A1 and A2. That is, the configuration of the system stream groups illustrated in FIGS. 10A to 10E represents the configuration described in the first embodiment, in which the scene A forms the third scene group constituted by the selectively reproducible scenes A1 and A2 and the scene C forms the second scene group constituted by the selectively reproducible scenes C1 and C2.

In this case, the title configuration illustrated in FIG. 8, i.e., the system stream configuration providing eight stories obtainable by multiplication of 2×2×2 can be provided. FIGS. 10B to 10E illustrate, as representative examples, the time charts in the reproduction of four of the eight stories.

The system streams A1, B1, B2, and C1 can be multiplexed in a similar method as the method employed for the system streams A, B1, B2, and C in the first embodiment. The present embodiment further performs a control to delay the lip-sync of each of audio streams B1 and B2 by the length of the audio gap GAP_B1_C of FIGS. 9A to 9C.

As illustrated in FIGS. 10A and 10B, the audio frames B1AF_1 to B1AF_8 of the system stream B1, the audio frames B2AF_1 to B2AF_5 of the system stream B2, and the audio frames B1AF_9 to B1AF_11 moved into the system stream C1 are delayed in lip-sync by the length of the audio gap GAP_B1_C1. Accordingly, the length of the audio gap GAP_B1_C1 can be reduced to zero in the system stream C1. As a result, the continuous and uninterrupted reproduction can be performed.

The delay of the audio signal B1 results in an increase in the length of the audio gap GAP_A1_B1 and delay of the lip-sync. In the present embodiment, the audio frame A1AF_13 of an audio stream A1 is moved into the system stream B1 to be added thereto to thereby reduce the length of the audio gap GAP_A1_B1 to zero. Accordingly, in the continuous reproduction of the system streams A1, B1, and C1, the scenes A1, B1, and C1 can be continuously and uninterruptedly reproduced.

Further, in the present embodiment, lip-sync adjustment similar to the lip-sync adjustment performed on the system streams B1 and B2 in the first embodiment is performed to make the system streams A1 and A2 selectively reproducible.

That is, as for the third selectively reproducible system stream group, it is now assumed that the reproduction end time of the last one of the video frames multiplexed in a system stream of the group (the system stream A1), the reproduction end time of the last one of the audio frames multiplexed in the system stream, and the difference therebetween (the difference between the video reproduction end time and the audio reproduction end time) are represented as T_VE_A1, T_AE_A1, and E_DIFF_A1, respectively. Further, it is assumed that the reproduction end time of the last one of the video frames multiplexed in the other system stream of the group (the system stream A2), the reproduction end time of the last one of the audio frames multiplexed in the system stream, and the difference therebetween (the difference between the video reproduction end time and the audio reproduction end time) are represented as T_VE_A2, T_AE_A2, and E_DIFF_A2, respectively. In this case, the multiplexing is performed with the decoding timing and the reproduction timing of each of the audio packets, i.e., the values of the DTS and the PTS of each of the packet headers set such that the differences E_DIFF_A1 and E_DIFF_A2 have the same value.

Further, in the present embodiment, the lip-sync of the initial audio frame of the system stream C2 (S_DIFF_C2) is determined to be equal to the already determined lip-sync of the system stream C1 to make the system streams C1 and C2 selectively reproducible.

It means that the difference between the video reproduction start time and the audio reproduction start time of the system stream C1 (S_DIFF_Cl) and the difference between the video reproduction start time and the audio reproduction start time of the system stream C2 (S_DIFF_C2) are equalized with each other.

Therefore, with the difference between the video reproduction end time and the audio reproduction end time of the system stream B1 (E_DIFF_B1) and the difference between the video reproduction end time and the audio reproduction end time of the system stream B2 (E_DIFF_B2) equalized with each other, the respective system streams constituting the first and second system stream groups can be connected together without a gap.

Accordingly, the lip-sync of the audio signals moved into the respective system streams can be equalized between the system streams A1 and A2, B1 and B2, and C1 and C2. As a result, continuous reproduction from the system stream A2 to the system stream B1 or B2 can be performed in the selection of either one of the scenes.

### (6) Operations (Third Embodiment)

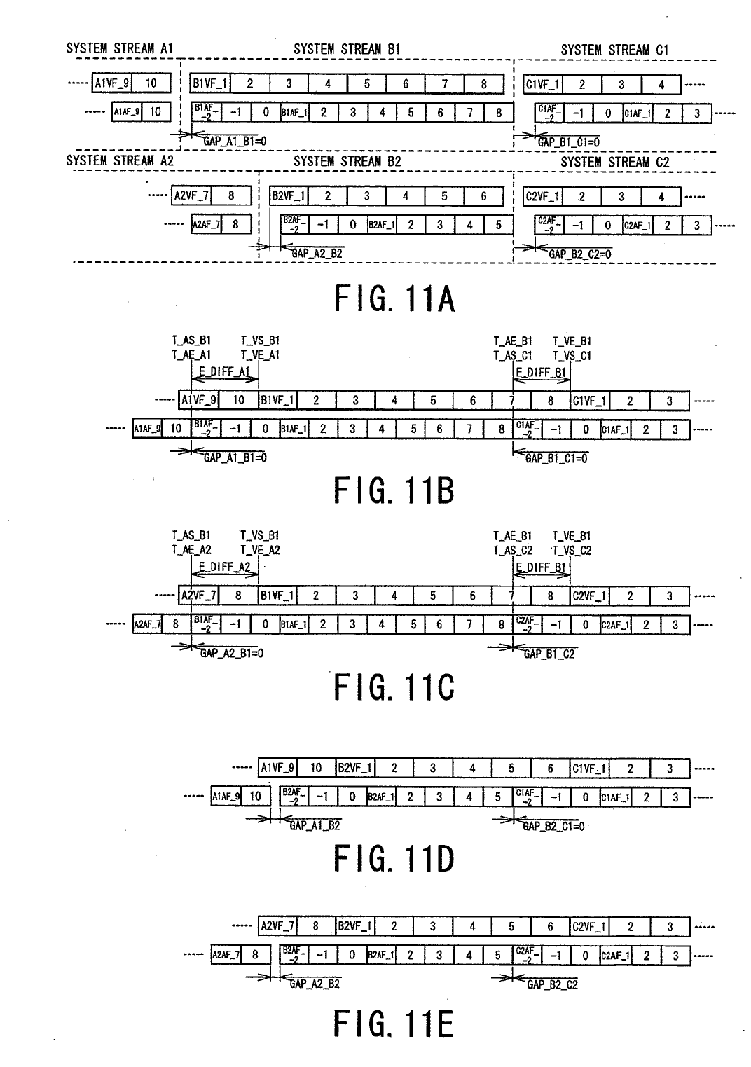

FIG. 11A is a diagram illustrating a configuration of system streams according to a third embodiment. FIGS. 11B to 11E are diagrams illustrating video and audio reproduction timings in the reproduction of the system streams. FIG. 11B illustrates a time chart in continuous reproduction of system streams A1, B1, and C1. FIG. 11C illustrates a time chart in continuous reproduction of system streams A2, B1, and C2. FIG. 11D illustrates a time chart in continuous reproduction of system streams A1, B2, and C1. FIG. 11E illustrates a time chart in continuous reproduction of system streams A2, B2, and C2.

As compared with the second embodiment illustrated in FIGS. 10A to 10E, the present embodiment forwardly extends the start frame of the audio stream of a target scene instead of moving into the target scene the audio frames of the scene reproduced before the target scene, to thereby make the length of the audio gap between the system streams less than one audio frame.

For example, in the second embodiment, the audio frames B1AF_9 to B1AF_11 of the scene B1 are moved into the system stream C2 to be multiplexed therein, as illustrated in FIGS. 10A, 10C, and 10E. Meanwhile, in the present embodiment, the audio frame of the scene C2 is forwardly extended to multiplex audio frames C2AF_-2 to C2AF_0. Normally, it is possible to perform the method by preparing the audio stream approximately 0.5 seconds before the start time of the video stream. According to the stream multiplexing method of the third embodiment, the audio packets multiplexed in each of the system streams can be constituted only by the audio packets of the continuous portion of the single audio stream corresponding to the video signal of the target system stream.

As compared with the stream multiplexing method according to the second embodiment, the stream multiplexing method according to the present embodiment can solve the issue likely to arise in the continuous reproduction of the system streams A2, B2, and C2, for example, i.e., the inclusion of a few of the audio frames of the scene A1 between the scenes A2 and B2 or the inclusion of a few of the audio frames of the scene B1 between the scenes B2 and C2.

### (7) Operations (Flowchart)

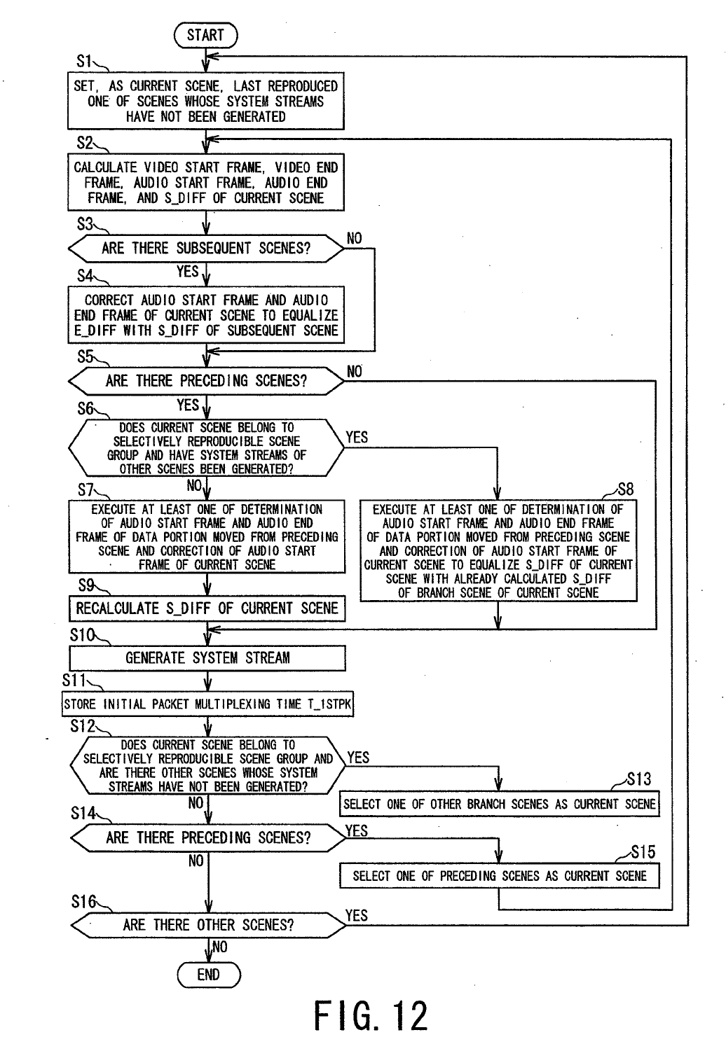

FIG. 12 is a flowchart for explaining an example of operations of the stream multiplexing apparatus according to the embodiment of the present invention, particularly operations relating to a video-audio synchronization control performed by the multiplexing control unit 14. In FIG. 12, reference numerals each including a number following the capital S indicate the respective steps of the flowchart. The following description will be made, with the system streams of the configurations illustrated in FIGS. 10A to 10E and 11A to 11E taken as examples.

Firstly, at Step S1, the scene which is the last to be reproduced in the reproduction order (hereinafter, referred to as the last reproduced scene) is extracted from the scenes whose system streams have not been generated, and the scene is determined as the current scene (the target scene). If the last reproduced scene belongs to a selectively and seamlessly reproducible scene group, one scene is selected from the scenes of the group whose system streams have not been generated, and the scene is determined as the current scene. In the first execution of Step S1, either one of the scenes C1 and C2 constituting the last scene in the reproduction order, e.g., the scene C1 is selected and determined as the current scene. The following description will be made of an example in which the Step S1 is first executed and the scene C1 is set as the current scene.

Then, at Step S2, the video start frame, the video end frame, the audio start frame, the audio end frame, and the video-audio start time difference S_DIFF of the current scene are calculated and recorded in the control information recording unit 18.

The title configuration information recording unit 13 is recorded with individual scene configuration information including the file name of each of the video stream and the audio stream used in the scene C1, and the start time and the end time of the scene C1. On the basis of the individual scene configuration information recorded in the title configuration information recording unit 13, the reproduction time information of the video stream recorded in the video stream recording unit 11, and the reproduction time information of the audio stream recorded in the audio stream recording unit 12, the multiplexing control unit 14 determines the start frame and the end frame of each of the streams to specify from which one to which one of the frames of the streams are to be multiplexed in the scene C1, and calculates a reproduction time difference S_DIFF_C1 between the video start frame and the audio start frame.

Then, at Step S3, determination is made on whether or not there are subsequent scenes to be seamlessly reproduced after the current scene. If the subsequent scenes are present, the procedure proceeds to Step S4. Meanwhile, if the subsequent scenes are absent, the procedure proceeds to Step S5. If the current scene is the scene C1, there is no scene reproduced after the scene C1. Therefore, the procedure proceeds to Step S5 on the basis of a determination result NO.

Then, at Step S5, determination is made on whether or not there are preceding scenes to be seamlessly reproduced before the current scene. If the preceding scenes are present, the procedure proceeds to Step S6. Meanwhile, if the preceding scenes are absent, the procedure proceeds to Step S10. If the current scene is the scene C1, the scenes B1 and B2 are present before the scene C1. Therefore, the procedure proceeds to Step S6 on the basis of a determination result YES.

Then, at Step S6, determination is made on whether or not the current scene belongs to a selectively reproducible scene group and the system streams of the other scenes of the same scene group (the branch scenes) have been generated. If the system streams of the other branch scenes have not been generated, the procedure proceeds to Step S7. Meanwhile, if the current scene does not belong to a selectively reproducible scene group or the system stream of at least one of the other branch scenes has been generated, the procedure proceeds to Step S8. In the case of the scene C1, the scene C1 and the selectively reproduced branch scene C2 are present, but the generation of the system stream has not yet been performed. Therefore, the procedure proceeds to Step S7 on the basis of a determination result NO.

Then, at Step S7, at least one of the determination of the audio start frame and the audio end frame of the data portion moved into the current scene from the preceding scene and the correction of the audio start frame of the current scene is executed.

The determination of the audio start frame and the audio end frame of the data portion moved into the current scene from the preceding scene can be executed by the method illustrated in the second embodiment (see FIGS. 10A to 10E). Specifically, the audio start frame and the audio end frame of the data portion moved into the current scene from the preceding scene can be determined as the first one and the last one of the audio frames of the preceding scene included in a time period from the multiplexing time of the initial packet of the initial video frame of the current scene to the reproduction start time of the initial audio frame of the current scene. For example, if the scene B1 is selected as the preceding scene, the audio frames B1AF_9 to B1AF_11 of the scene B1, which are included in a time period from the multiplexing start time of the initial video frame C1VF_l of the scene C1 to the reproduction start time of the initial audio frame C1AF_1 of the scene C1, are moved into the system stream C1 to be multiplexed therein.

As a result, the audio gap GAP_B1_C1 between the audio signals B1 and C1 becomes smaller than one audio frame. Further, in the example of FIGS. 10A and 10B, the time difference S_DIFF between the reproduction start time of the first reproduced video frame (C1VF_l in FIGS. 10A and 10B) and the reproduction start time of the first reproduced audio frame (B1AF_9 in FIGS. 10A and 10B) is corrected such that the audio gap GAP_B1_C1 between the audio signals B1 and C1 becomes zero.

Meanwhile, the correction of the audio start frame of the current scene can be executed by the method illustrated in the third embodiment (see FIGS. 11A to 10E). Specifically, instead of the moving of the audio frames B1AF_9 to B1AF_11 into the current scene from the scene B1, the forward extension of the audio start frame of the scene C1 is performed.

Further, the audio gap GAP_B1_C1 between the audio signals B1 and C1 may be made smaller than one audio frame partially by moving audio frames into the current scene from the preceding scene and partially by forwardly extending the audio start frame of the current scene.

Upon execution of Step S7, the audio frame first to be reproduced in the scene C1 is changed.

Then, at Step S9, the difference S_DIFF between the video reproduction start time and the audio reproduction start time is recalculated.

According to Steps S1 to S9 described above, it is possible to acquire the video stream and the audio stream to be multiplexed in the system stream, the start frame and the end frame of each of the streams to be multiplexed in the system stream, and the difference S_DIFF between the video reproduction start time and the audio reproduction start time.

Then, at Step S10, on the basis of the acquired information, the respective frames are sequentially packetized and multiplexed to generate the system stream. As the packet multiplexing method for a single system stream, a variety of conventional packet multiplexing methods have been known, and an arbitrary one of the methods can be employed.

Then, at Step S11, an initial packet multiplexing time T_1STPK (a relative time with respect to the video reproduction start time) of the generated system stream (see PACKET MULTIPLEXING in FIG. 4) is stored in the control information recording unit 18.

Subsequently, at Steps S12 to S16, a process of selecting from the title configuration information recording unit 13 the scene to be processed next is executed.

First, at Step S12, determination is made on whether or not the current scene belongs to a selectively reproducible scene group and the other scenes of the same scene group include the scenes whose system streams have not been generated. If the other scenes of the same scene group include the scenes whose system streams have not been generated, the procedure proceeds to Step S13. Meanwhile, if such scenes are absent or the current scene does not belong to a selectively reproducible scene group, the procedure proceeds to Step S14.

Then, at Step S13, one scene is selected and determined as the current scene from the branch scenes whose system streams have not been generated. The procedure then returns to Step S2 to execute the process of generating the system stream of the scene.

Meanwhile, if it is determined at Step S12 that the other scenes of the same scene group do not include the scenes whose system streams have not been generated or the current scene does not belong to a selectively reproducible scene group, determination is made at Step S14 on whether or not there are preceding scenes to be seamlessly reproduced before the current scene. If the preceding scenes to be seamlessly reproduced before the current scene are present, the procedure proceeds to Step S15. Meanwhile, if the preceding scenes are absent, the procedure proceeds to Step S16.

Then, at Step S15, one of the preceding scenes is selected and determined as the current scene. The procedure then returns to Step S2 to execute the process of generating the system stream of the scene.

Meanwhile, if it is determined at Step S14 that the preceding scenes to be seamlessly reproduced before the current scene are absent, determination is made at Step S16 on whether or not there are other scenes whose system streams have not been generated. If other scenes whose system streams have not been generated are present, the procedure returns to Step S1 to select the scene to be processed next, and the process of generating the system stream is executed. Meanwhile, if other scenes whose system streams have not been generated are absent, the absence indicates the completion of the generation of the system streams of all scenes. Therefore, the sequence of procedure is completed.

For example, if the processes of Steps S1 to S11 have been performed on the scene C1 illustrated in FIGS. 10A and 11A, the scene C2 constituting the branch scene of the scene C1 still remains at Step S12. Thus, the determination result of Step S12 is YES. As a result, the scene C2 is set as the current scene at Step S12, and the procedure returns to Step S2.

From Step S2 to Step S5, the scene C2 is also subjected to a procedure similar to the procedure performed on the scene C1.

If the current scene is the scene C2 at Step S6, the scene C1 is present as the branch scene whose system stream has been generated. Thus, with the determination result of YES, the procedure proceeds to Step S8.

At Step S8, at least one of the determination of the audio start frame and the audio end frame of the data portion moved into the current scene from the preceding scene and the correction of the audio start frame of the current scene is executed such that the video-audio start time difference S_DIFF_C2 of the current scene is equalized with the already calculated video-audio start time difference S_DIFF_C1. Then, the procedure proceeds to Step S10.

That is, the branch scene which belongs to the same scene group, and the system stream of which is generated in the second or later place, conforms to the video-audio start time difference S_DIFF calculated at Step S9 in the sequence of procedure performed on the first branch scene.

At the subsequent Steps S10 and S11, the scene C2 is subjected to processes similar to the processes performed on the scene C1.

At Step S12, the scene C2 is the branch scene whose system stream is generated last among the system streams of the scenes belonging to the same scene group. Thus, the determination result of Step S12 is NO, and the procedure proceeds to Step S14.

At Step S14, there are the preceding scenes B1 and B2 seamlessly reproduced before the scene C2 constituting the current scene. Thus, the determination result of Step S14 is YES. Then, at Step S15, the scene B1 constituting one of the preceding scenes is selected and determined as the current scene, and the procedure returns to Step S2.

At Step S2, the scene B1 is also subjected to a process similar to the process performed on the scenes C1 and C2.

At Step S3, the scene B1 is followed by the scenes C1 and C2 to be seamlessly reproduced after the scene B1. Thus, with the determination result of YES, the procedure proceeds to Step S4.

At Step S4, the audio start frame and the audio end frame of the current scene are corrected such that the video-audio end time difference E_DIFF (=E_DIFF_B1) is equalized with the video-audio start time difference S_DIFF (=S_DIFF_C1=S_DIFF_C2) of the subsequent scene.

As a result, in the continuous reproduction of the system streams B1 and C1 or C2 in FIGS. 10B, 10C, 11B, and 11C, the audio frames multiplexed in the system stream B1 and the audio frames multiplexed in the system stream C1 or C2 can be continuously reproduced without a gap.

Thereafter, the scene B1 is subjected to the processes of Steps S5 to S7 and S9 in a similar manner as in the scene C1. Thereby, the start frame and the end frame of the video stream, the start frame and the end frame of the audio stream, and the video-audio synchronization are determined.

Then, at Step S10, the system stream is generated. The scene B1 is followed by the scenes C1 and C2 as the subsequent scenes to be seamlessly reproduced after the scene B1. Thus, the multiplexing position needs to be controlled such that the multiplexing time of the last pack of the scene B1 precedes the multiplexing time of the initial packet of each of the system streams C1 and C2. Therefore, the earlier time is selected for use from the initial packet multiplexing time T_1STPK (the relative time with respect to the video reproduction start time) of the system stream C1 and the T_1STPK of the system stream C2, which have been recorded in the control information recording unit 18 at Step S11 in the generation of the system streams C1 and C2. Then, the multiplexing time is controlled such that the last packet multiplexing time of the system stream B1 precedes the earlier time. Accordingly, it is possible to accurately know the last packet multiplexing time of the system stream B1, and to multiplex a larger amount of data without waste.

Thereafter, the processing is performed on the scenes B2, A1, and A2 in this order in accordance with the procedure illustrated in FIG. 12. Accordingly, the system streams B2, A1, and A2 illustrated in FIGS. 10A and 11A can be generated.

In the stream multiplexing apparatus according to the embodiment of the present invention, a selectively reproducible scene group does not need to include in each of the scenes thereof a part of the data of the scene reproduced after the scene group. Thus, it is possible to provide, in a simple method and without holding redundant data, a title configuration enabling seamless reproduction of a plurality of stories which share at least one system stream. Therefore, an editing process is unnecessary, and an increase in data can be suppressed.

Further, in this case, the interruption of the sound can be reduced in the reproduction of the respective stories. Further, the audio gap included in a selectively reproducible scene group is limited to up to one in each scene. Therefore, a load imposed on a decoder by the stop and restart of the decoding process and so forth can be reduced.

Further, the stream multiplexing apparatus according to the embodiment of the present invention can provide a title configuration enabling seamless reproduction of a plurality of selectively reproducible system streams and another plurality of selectively reproducible system streams. Furthermore, the stream multiplexing apparatus according to the embodiment of the present invention can continuously multiplex the packets without waste, even in the vicinity of connection points of the system streams.

The present invention is not directly limited to the embodiments described above, and can be embodied in modifications of the constituent elements at the implementation stage within the scope not departing from the gist of the invention. Further, a variety of inventions can be formed by appropriate combinations of a plurality of constituent elements disclosed in the embodiments described above. For example, some constituent elements may be eliminated from all the constituent elements disclosed in the embodiments. Further, constituent elements of different embodiments can be appropriately combined.

For example, the examples described above illustrate the tile configuration in which one video stream and one audio stream are multiplexed together. However, the present invention is not limited thereto. Thus, the present invention can be implemented in a similar method also in the multiplexing of a plurality of video streams and a plurality of audio streams or in the multiplexing of another stream.

Further, the embodiments of the present invention illustrate the example in which the respective steps of the flowchart are chronologically performed in accordance with the described order. However, the steps also include processes which are not necessarily performed chronologically but are performed in parallel or individually.

What is claimed is:

1. A stream multiplexing apparatus for multiplexing an encoded video stream and an encoded audio stream in a system stream, the stream multiplexing apparatus comprising:
a video packetizer configured to fragment the video stream into video packets, each of the video packets comprising a predetermined size, and to add video decoding synchronization information comprising at least information of an input time to a video decoder and a video reproduction time to each of the video packets;
an audio packetizer configured to fragment the audio stream into audio packets each of the audio packets comprising a predetermined size, and to add audio decoding synchronization information comprising at least information of an input time to an audio decoder and an audio reproduction time to each of the audio packets;
a packet multiplexer configured to multiplex the video packets and the audio packets in order to generate the system stream; and
a multiplexing controller configured to control the video packetizer, the audio packetizer, and the packet multiplexer in order to control a multiplexing order and a multiplexing position of the video packets and the audio packets,
wherein the multiplexed stream comprises a first system stream and a second system stream, the first system stream being comprised in a first system stream group comprising one or more system streams and subject to be selectively and seamlessly reproduced and the second system stream being comprised in a second system stream group comprising one or more system streams and subject to be selectively and seamlessly reproduced subsequently to the first system stream in the first system stream group, and the multiplexing controller is configured to control the audio decoding synchronization information and a packetization start position and a packetization end position of the audio stream of system streams in the first and second system stream groups such that a difference between a video reproduction end time and an audio reproduction end time of the system streams in the first system stream group is equalized with a difference between a video reproduction start time and an audio reproduction start time of the system streams in the second system stream group.

2. The stream multiplexing apparatus of claim 1,
wherein the multiplexed stream comprises a third system stream in a third system stream group comprising one or more system streams and subject to be selectively and seamlessly reproduced before the first system stream in the first system stream group, the multiplexing controller is configured to control the video packetizer, the audio packetizer, and the packet multiplexer such that a difference between a video reproduction end time and an audio reproduction end time of system streams in the third system stream group is equalized with the difference between a video reproduction start time and an audio reproduction start time of the system streams in the first system stream group, and that the system streams in the first system stream group comprises up to one audio gap.

3. The stream multiplexing apparatus of claim 2,
wherein the multiplexing controller is configured to control the video packetizer, the audio packetizer, and the packet multiplexer such that the length of the audio gap of at least one of the system streams in the first system stream group is zero.

4. The stream multiplexing apparatus of claim 1,
wherein the multiplexing controller is configured to control the video packetizer, the audio packetizer, and the packet multiplexer such that only a continuous portion of the single audio stream in at least one of the system streams in the first and second system stream groups is continuously reproduced.

5. The stream multiplexing apparatus of claim 1,
wherein the multiplexing controller is configured to control the video packetizer, the audio packetizer, and the packet multiplexer such that the multiplexing is sequentially performed from the last to the first of the system streams in a reproduction order, and that the multiplexing of a system stream immediately preceding the subsequent system stream in the reproduction order is performed to adjust a difference between a video reproduction end time and an audio reproduction end time to a difference between the video reproduction start time and the audio reproduction start time of a subsequent system stream in the reproduction order.

6. The stream multiplexing apparatus of claim 1,
wherein the multiplexing controller is configured to control the video packetizer, the audio packetizer, and the packet multiplexer such that the multiplexing is performed in order to delay audio reproduction with respect to video reproduction for controlling a difference between the video reproduction start time and the audio reproduction start time and a difference between the video reproduction end time and the audio reproduction end time of the system stream.

7. A stream multiplexing method for multiplexing an encoded video stream and an encoded audio stream into a system stream, the stream multiplexing method comprising:
fragmenting the video stream into video packets of a predetermined size, and adding video decoding synchronization information comprising information of an input time to a video decoder and a video reproduction time to the video packets;
fragmenting the audio stream into audio packets of a predetermined size, and adding audio decoding synchronization information comprising information of an input time to an audio decoder and an audio reproduction time to the audio packets;
multiplexing the video packets and the audio packets to the system stream;
controlling multiplexing orders and multiplexing positions of the video packets and the audio packets;
multiplexing a first system stream in a first system stream group comprising one or more system streams and subject to be selectively and seamlessly reproduced, and a second system stream comprised in a second system stream group including one or more system streams and subject to be selectively and seamlessly reproduced subsequently to the system stream included in the first system stream group;
controlling the multiplexing order and the multiplexing position comprises controlling the audio decoding synchronization information, a packetization start position, and a packetization end position of the audio stream of the system streams in the first and second system stream groups such that a difference between a video reproduction end time and an audio reproduction end time of the system streams in the first system stream group is equalized with a difference between a video reproduction start time and an audio reproduction start time of the system streams in the second system stream group.

8. The stream multiplexing method of claim 7,
wherein the multiplexing comprises a third system stream in a third system stream group comprising one or more system streams and subject to be selectively and seamlessly reproduced before the first system stream in the first system stream group the controlling the multiplexing orders and the multiplexing positions the video packets and the audio packets, further comprises:
equalizing the difference between a video reproduction end time and an audio reproduction end time of the system streams in the third system stream group with the difference between a video reproduction start time and an audio reproduction start time of the system streams in the first system stream group; and
keeping an audio gap of the system streams in the first system stream group up to one.

9. The stream multiplexing method of claim 8,
wherein the controlling the multiplexing order and the multiplexing position of the video packets and the audio packets such that the length of the audio gap of at least one of the system streams in the first system stream group is zero.

10. The stream multiplexing method of claim 7,
wherein the controlling the multiplexing order and the multiplexing position of the video packets and the audio packets further comprises:
reproducing a continuous portion of the single audio stream in at least one of the system streams in the first and second system stream groups.

11. The stream multiplexing method of claim 7,
wherein the controlling the multiplexing order and the multiplexing position of the video packets and the audio packets, further comprises:
multiplexing sequentially from the last to the first of the system streams in a reproduction order; and
multiplexing a system stream immediately preceding the subsequent system stream in the reproduction order in order to adjust a difference between a video reproduction end time and an audio reproduction end time to a difference between a video reproduction start time and an audio reproduction start time of a subsequent system stream in the reproduction order.

12. The stream multiplexing method of claim 7,
wherein controlling the multiplexing order and the multiplexing position of the video packets and the audio packets further comprises:
delaying the multiplexing audio reproduction with respect to video reproduction in controlling of the difference between the video reproduction start time and the audio reproduction start time and the difference between the video reproduction end time and the audio reproduction end time of the system stream.

13. A recording medium for recording a system stream, in which an encoded video stream and an encoded audio stream are multiplexed,
wherein the recording medium is recorded with a first system stream group comprising one or more system streams and subject to be selectively and seamlessly reproduced and a second system stream group comprising one or more system streams and subject to be selectively and seamlessly reproduced subsequently to the first system stream group, and
wherein a difference between a video reproduction end time and an audio reproduction end time of the system streams in the first system stream group is equal to a difference between a video reproduction start time and an audio reproduction start time of the system streams in the second system stream group.

14. The recording medium of claim 13,
wherein the recording medium is recorded with a third system stream group comprising one or more system streams and subject to be selectively and seamlessly reproduced before the first system stream group in addition to the first and second system stream groups,
wherein a difference between a video reproduction end time and an audio reproduction end time of the system streams in the third system stream group is equal to a difference between a video reproduction start time and an audio reproduction start time of the system streams in the first system stream group, and
wherein the system streams in the first system stream group comprises up to one audio gap.

15. The recording medium of claim 14,
wherein the length of the audio gap of at least one of the system streams in the first system stream group is zero.

16. The recording medium of claim 13,
wherein the multiplexing is performed such that only a continuous portion of the single audio stream in at least one of the system streams in the first and second system stream groups is continuously reproduced.
